(19) United States
(12) Patent Application Publication
(10) Pub. No.: US 2025/0045688 A1
(43) Pub. Date: Feb. 6, 2025

(54) DELIVERY MANAGEMENT DEVICE

(71) Applicant: HONDA MOTOR CO., LTD., Tokyo (JP)

(72) Inventors: Kentaro SUGIMURA, Saitama (JP); Yuji MATSUO, Tokyo (JP); Soji KASHIMA, Saitama (JP); Michiyo INOUE, Tokyo (JP)

(73) Assignee: HONDA MOTOR CO., LTD., Tokyo (JP)

(21) Appl. No.: 18/714,095

(22) PCT Filed: Nov. 29, 2021
(86) PCT No.: PCT/JP2021/043552

§ 371 Date: May 29, 2024

(51) Int. Cl. G06Q 10/0836

(52) U.S. Cl. CPC G06Q 10/0836

(57) ABSTRACT

A delivery management device (10) transmits delivery instruction information for a delivery person on the basis of battery delivery request information that includes position information of a delivery destination. In addition, the delivery instruction information includes: position information of a storage appliance (5) for storing a battery which can be delivered to the delivery destination; and position information of the delivery destination. In addition, the delivery person is selected, from among preregistered delivery person candidates, on the basis of: position information of the delivery person candidates; and position information of at least either one of the storage appliance (5) and the delivery destination.

### TECHNICAL FIELD

The present invention relates to a delivery management device.

### BACKGROUND ART

In recent years, an effort to realize a low-carbon or decarbonized society has become active as a concrete measure against global climate change.

Additionally, consideration is being given to building a battery sharing network as a regional energy infrastructure. In addition, a service is being considered in which batteries are delivered from battery storage devices provided in various locations to ordering sources (delivery destinations) such as event venues in a battery sharing network. For example, many electronic devices are used outdoors at large-scale outdoor music festivals. In this case, many portable discharge machines are expected to be used from a viewpoint of convenience, but since commercial power sources are not necessarily provided nearby, many removable batteries may be used. In order to deal with such cases, a service is being considered that delivers a battery from a storage location to an ordering source (delivery destination).

Patent Literature 1 describes delivering a lead-acid battery to an ordering source using delivery means such as a vehicle equipped with a lead-acid battery and searching for a route that requires shortest time among routes of the delivery means for moving the delivery means after delivery to a storage location of the lead-acid battery as a shortest route.

### CITATION LIST

### Patent Literature

Patent Literature 1: JP2007-099419A

### SUMMARY OF INVENTION

### Technical Problem

Patent Literature 1 describes that a route search is performed in consideration of the storage location of the battery, but does not disclose selection of a delivery means such as a vehicle for delivering the battery. Therefore, there is room for improvement in a method of delivering batteries to the ordering source.

The present invention provides a delivery management device that can instruct delivery to a deliverer who can efficiently deliver a battery.

### Solution to Problem

The present invention is,
a delivery management device for selecting a deliverer based on delivery request information of a battery including location information of a delivery destination, and for transmitting delivery instruction information to the deliverer, where
the delivery instruction information includes location information of a storage device storing a battery that can be delivered to the delivery destination and the location information of the delivery destination, and
the deliverer is selected from deliverer candidates registered in advance based on location information of the deliverer candidates and at least one of the location information of the storage device and the location information of the delivery destination.

### Advantageous Effects of Invention

According to the present invention, a delivery instruction can be given to a deliverer who can efficiently deliver a battery.

### BRIEF DESCRIPTION OF DRAWINGS

FIG. 1 is a diagram illustrating an example of a delivery system 100 to which a delivery management device 10 is applied.

FIG. 2 is a sequence diagram illustrating an example of operations in the delivery system 100.

FIG. 3 is a diagram illustrating an example of a delivery request screen displayed on an information terminal 21 in step S21 of FIG. 2.

FIG. 4 is a diagram illustrating an example of a delivery instruction screen displayed on an information terminal 22 in step S25 of FIG. 2.

FIG. 5 is a diagram illustrating an example of information on storage device candidates that can be acquired by the delivery management device 10.

FIG. 6 is a diagram illustrating an example of information on deliverer candidates that can be acquired by the delivery management device 10.

FIG. 7 is a flowchart illustrating an example of processing by the delivery management device 10.

FIG. 8 is a flowchart illustrating a specific example of step S72 in FIG. 7.

FIG. 9 is a flowchart illustrating a specific example of step S73 in FIG. 7.

FIG. 10 is a flowchart illustrating a specific example of step S75 in FIG. 7.

FIG. 11 is a diagram illustrating another example of the delivery instruction screen 40.

### DESCRIPTION OF EMBODIMENTS

Hereinafter, one embodiment of a delivery management device of the present invention will be described based on accompanying drawings.

### Embodiment

Hereinafter, a delivery management device 10 as an embodiment of the delivery management device of the present invention will be described based on the accompanying drawings.

### <Delivery Management Device 10>

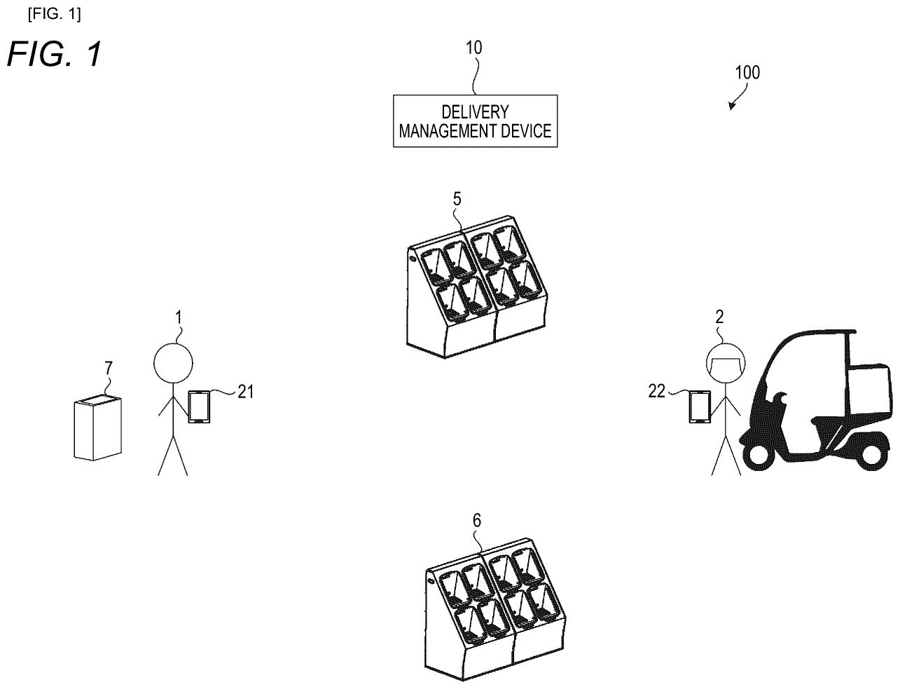

FIG. 1 is a diagram illustrating an example of a delivery system 100 to which the delivery management device 10 is applied. The delivery system 100 includes the delivery management device 10, information terminals 21, 22, and storage devices 5, 6. The storage devices 5, 6 are devices that store batteries that can be delivered upon request. For example, the battery may be a secondary battery, and the storage devices 5. 6 may be chargers that charge the stored batteries.

The batteries stored by the storage devices 5, 6 are, for example, batteries that can be used in a battery-powered portable discharge machine 7 used at event venues and the like. The portable discharge machine 7 is, for example, an AC power source having an inverter, and is a portable discharge machine that can generate AC power from a replaceable battery and supply the generated AC power to other electronic devices.

The delivery management device 10 is a server that manages delivery of batteries stored in storage devices such as the storage devices 5, 6. Further, the delivery management device 10 may manage return of a used battery delivered from a storage device to the storage device, or manage delivery of food/drinks that is performed together with the delivery of the battery.

The delivery management device 10 can communicate directly or indirectly with the information terminals 21, 22. Further, the delivery management device 10 may be able to communicate directly or indirectly with the storage devices 5, 6. The delivery management device 10 may be a virtual server (cloud server) realized in a cloud computing service, or may be a physical server realized as a single device.

The information terminal 21 is an information terminal such as a smartphone owned by a requester 1. The requester 1 is a user at a location (for example, an event venue) where the battery delivered by the delivery system 100 is used. The information terminal 22 is an information terminal such as a smartphone owned by a delivery person 2. The delivery person 2 is a user selected by the delivery management device 10 as a delivery person who will deliver the battery to a location (for example, an event venue) of the requester 1 from among deliverer candidates registered in advance.

### <Hardware Configuration of Delivery Management Device 10>

The delivery management device 10 illustrated in FIG. 1 includes, for example, a processor, a memory, and a communication interface. The processor is a circuit that performs signal processing, and is, for example, a central processing unit (CPU) that controls an entirety of the delivery management device 10. The processor may be realized by other digital circuits such as a field programmable gate array (FPGA) or a digital signal processor (DSP). Further, the processor may be realized by combining a plurality of digital circuits.

The memory includes, for example, a main memory and an auxiliary memory. The main memory is, for example, a random access memory (RAM). The main memory is used as a work area for the processor. The auxiliary memory is, for example, a nonvolatile memory such as a magnetic disk, an optical disk, or a flash memory. Various programs for operating the delivery management device 10 are stored in the auxiliary memory. Programs stored in the auxiliary memory are loaded into main memory and executed by the processor.

The communication interface is a communication interface that performs communication with other devices (for example, the information terminals 21, 22 and the storage devices 5, 6) under the control of the processor. For example, the communication interface communicates with other devices via a wide area communication network such as the Internet. The communication interface may be a wired communication interface that performs wired communication such as a wired LAN (Local Area Network), or may be a wireless communication interface that performs wireless communication such as cellular communication or wireless LAN.

### <Hardware Configuration of Information Terminal 21>

The information terminal 21 includes, for example, a processor, a memory, a communication interface, a user interface, and a global navigation satellite system (GNSS). The processor, memory, and communication interface of the information terminal 21 are respectively similar to the processor, memory, and communication interface of the delivery management device 10. However, since the information terminal 21 is a portable information terminal owned by the requester 1, the communication interface of the information terminal 21 is preferably a wireless communication interface.

The user interface of the information terminal 21 includes, for example, an input device that receives operation input from a user (for example, requester 1), an output device that outputs information to the user, and the like. The input device can be realized by, for example, a pointing device (for example, a mouse), keys (for example, a keyboard), a remote controller, or the like. The output device can be realized by, for example, a display or a speaker. Further, the input device and the output device may be realized by a touch panel or the like. The user interface of the information terminal 21 is controlled by the processor of the information terminal 21.

The GNSS of the information terminal 21 is a device for the information terminal 21 to specify a current position of the information terminal 21, and is, for example, a global positioning system (GPS). The GNSS of the information terminal 21 is controlled by the processor of the information terminal 21.

### <Hardware Configuration of Information Terminal 22>

The configuration of the information terminal 22 is similar to the configuration of the information terminal 21.

### <Operation in Delivery System 100>

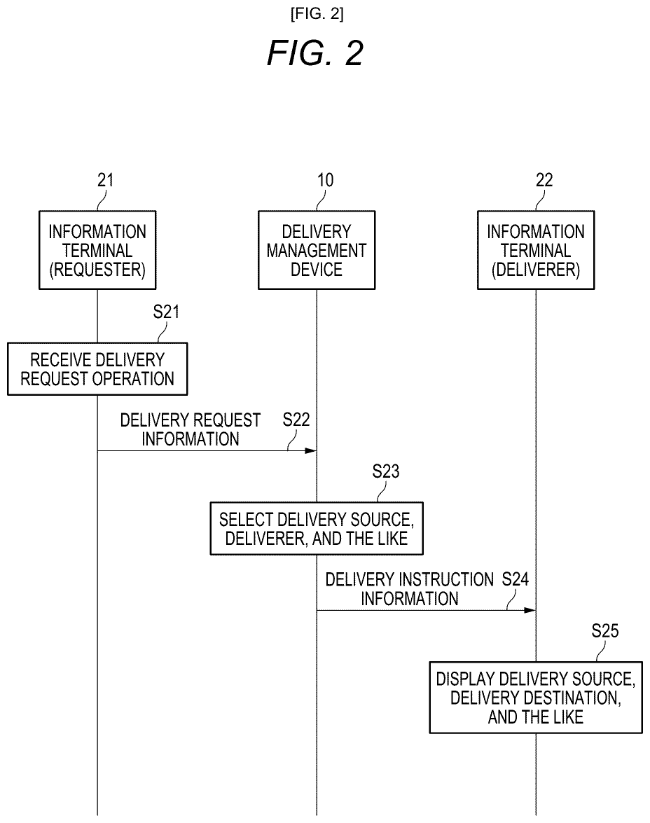

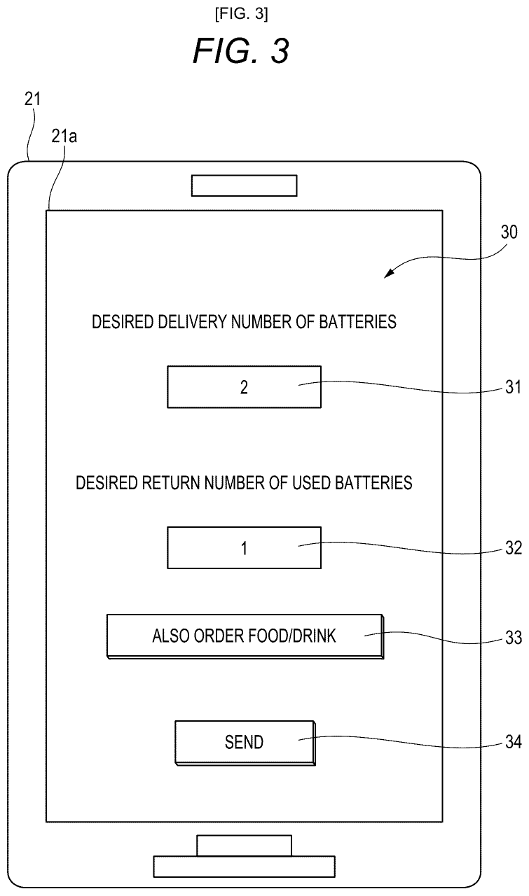

FIG. 2 is a sequence diagram illustrating an example of operations of the delivery system 100. First, the information terminal 21 receives a delivery request operation for requesting battery delivery from the requester 1 (step S21). For example, the information terminal 21 receives a delivery request operation by displaying a delivery request screen for receiving information such as the number of batteries for which delivery is requested. A specific example of the delivery request screen will be described with reference to FIG. 3.

Next, the information terminal 21 transmits delivery request information to the delivery management device 10 (step S22). The delivery request information transmitted in step S22 includes, for example, location information of a battery delivery destination and information on a delivery number of batteries indicating the number of batteries for which delivery is requested. The location information of the battery delivery destination is, for example, location information indicating the location of the information terminal 21. The location information of the information terminal 21 is acquired, for example, by GNSS provided in the information terminal 21. Alternatively, the location information of the battery delivery destination may be the location information of the delivery destination designated by the requester 1 through a delivery request operation in step S21. Further, the location information may be coordinate information such as latitude and longitude, or may be information such as an address.

Next, the delivery management device 10 selects the delivery source, deliverer, and the like of the battery based on the delivery request information received in step S22 (step S23). The battery delivery source is selected from storage device candidates registered in advance, including the storage devices 5, 6. The battery deliverer is selected from deliverer candidates registered in advance, including the delivery person 2. In this example, it is assumed that storage device 5 is selected as the delivery source of the distributed battery, and delivery person 2 is selected as the delivery person of the battery.

Next, the delivery management device 10 transmits delivery instruction information to the delivery person 2, which is the deliverer selected in step S23 (step S24). Specifically, the delivery management device 10 transmits delivery instruction information to the information terminal 22 of the delivery person 2. The delivery instruction information transmitted in step S24 includes the location information of the storage device 5 selected as the battery delivery source in step S23, and the location information of the delivery destination included in the delivery request information.

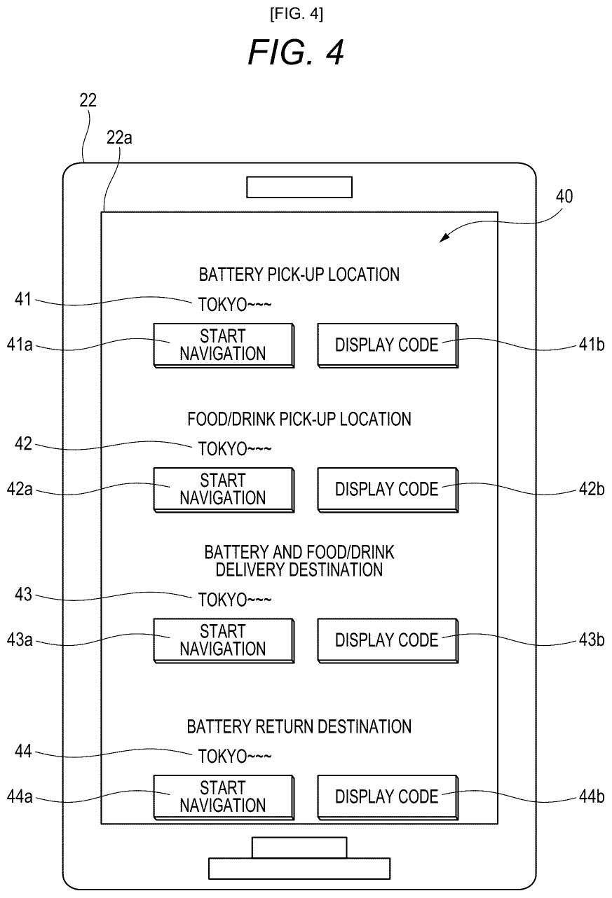

Next, the information terminal 22 displays a delivery instruction screen (for example, see FIG. 4) indicating the delivery source and destination of the battery to the delivery person 2 based on the delivery request information received in step S24 (step S25). A specific example of the delivery instruction screen will be described with reference to FIG. 4.

The delivery person 2 delivers the battery based on the delivery instruction screen displayed in step S25. In this example, the delivery person 2 first moves to the storage device 5, acquires a battery from the storage device 5, and delivers the battery to the delivery destination (the location of the information terminal 21). As a result, the requester 1, who requested delivery of the battery, can receive the battery.

### <Delivery Request Screen Displayed on Information Terminal 21 in Step S21 of FIG. 2>

FIG. 3 is a diagram illustrating an example of the delivery request screen displayed on the information terminal 21 in step S21 of FIG. 2. A touch panel 21a illustrated in FIG. 3 is a touch panel included in the user interface of the information terminal 21. In step S21 of FIG. 2, the information terminal 21 displays, for example, a delivery request screen 30 illustrated in FIG. 3 on the touch panel 21a.

The delivery request screen 30 includes a desired delivery number of batteries input section 31 and a send button 34. Further, the delivery request screen 30 may include a desired return number of batteries input section 32 and a food/drink delivery instruction button 33.

The desired delivery number of batteries input section 31 is an area for the requester 1 to input the number of batteries that the requester 1 desires to deliver. In the example of FIG. 3, “2” is input in the desired delivery number of batteries input section 31. The desired return number of batteries input section 32 is an area for inputting the number of used batteries that requester 1 desires to return. In the example of FIG. 3, “1” is input in the desired return number of batteries input section 32.

The food/drink delivery instruction button 33 is an area for the requester 1 to request delivery of food/drinks together with a battery. When the requester 1 performs an instruction operation (for example, a touch operation) on the food/drink delivery instruction button 33, the screen of the touch panel 21a changes from the delivery request screen 30 to the food/drink delivery request screen (not illustrated). In the food/drink delivery request screen, the requester 1 can instruct the restaurant and the food/drink (type and quantity). When the restaurant and food/drink instructions are completed, the screen of the touch panel 21a returns from the food/drink delivery request screen to the delivery request screen 30.

The send button 34 is an area for transmitting delivery request information based on each piece of information input by the requester 1 on the delivery request screen 30 to the delivery management device 10. When the instruction operation of the send button 34 is performed, the information terminal 21 generates delivery request information including location information (for example, the location information of the information terminal 21) of the delivery destination and information on a delivery number indicating the desired delivery number of batteries inputted to the desired delivery number of batteries input section 31, and then the information terminal 21 transmits the generated delivery request information to the delivery management device 10.

Also, when a number equal to or greater than 1 is input to the desired return number of batteries input section 32, the information terminal 21 includes return request information including information on a return number of used batteries indicating the number input to the desired return number of batteries input section 32 in the generated delivery request information. In addition, when the instruction operation of the food/drink delivery instruction button 33 is performed and the restaurant and food/drink are specified on the food/drink delivery request screen, food/drink delivery request information indicating the restaurant and food/drink is included in the generated delivery request information.

Requests for battery return are optional, and the requester 1 may perform the instruction operation of the send button 34 without performing an input operation to the desired return number of batteries input section 32, or by inputting “0” or the like to the desired return number of batteries input section 32. Further, the request for food/drink delivery is optional, and the requester 1 may perform the instruction operation of the send button 34 without performing an instruction operation of the food/drink delivery instruction button 33.

### <Generation of Delivery Instruction Information by Delivery Management Device 10>

When the delivery management device 10 receives the delivery request information, the delivery management device 10 selects a storage device as a battery delivery source and a battery deliverer. Further, when the delivery request information includes return request information, the delivery management device 10 selects a used battery return destination. Details of these selections will be described below. Further, the delivery management device 10 generates and transmits delivery instruction information based on the selection result.

Further, the delivery management device 10 may include, in the delivery instruction information, battery acquisition authentication information that is valid only in the storage device as the selected delivery source. The battery acquisition authentication information is key information that can be used for authentication to acquire a battery from the storage device. For example, storage devices such as the storage devices 5 and 6 have their batteries stored in locked containers so that the batteries cannot be taken out, and when the battery acquisition authentication information is input, the storage device becomes ready to unlock the container and the battery can be taken out. Further, in this case, notification information indicating that the battery has been taken out may be transmitted from the storage device to the delivery management device 10.

Further, the delivery management device 10 may include delivery completion authentication information, which is valid only at an information terminal provided at the delivery destination, in the delivery instruction information. The delivery completion authentication information is key information that can be used for authentication at the delivery destination to confirm delivery completion. The information terminal provided at the delivery destination may be, for example, the information terminal 21 that made the delivery request, or may be the information terminal provided at the battery storage location designated by the information terminal 21. When delivery completion authentication information is input into an information terminal provided at the delivery destination, notification information indicating that delivery has been completed is transmitted from the information terminal to the delivery management device 10.

Further, when the delivery management device 10 selects a storage device as a used battery return destination and includes return request information in the delivery instruction information, the delivery management device 10 may include battery return authentication information that is valid only for that storage device in the delivery instruction information. Battery return authentication information is key information that can be used for authentication to return a used battery to a storage device. For example, storage devices such as the storage devices 5, 6 have empty containers in which used batteries can be returned locked, making it not possible to return used batteries, and when the battery return authentication information is input, the storage devices unlock the containers and become ready to return the used batteries. Further, in this case, notification information indicating that the battery has been returned may be transmitted from the storage device to the delivery management device 10.

Further, when the delivery management device 10 includes food/drink delivery request information designating a restaurant in the delivery instruction information, the delivery management device 10 may include food/drink acquisition authentication information that is valid only at the restaurant in the delivery instruction information. The food/drink acquisition authentication information is key information that can be used for authentication for receiving food/drink at a restaurant. For example, the restaurant is equipped with an information terminal where a user can input the food/drink acquisition authentication information, and by inputting the food/drink acquisition authentication information into the information terminal, the user can receive food/drink from a restaurant staff. Further, in this case, notification information indicating that the food/drink has been taken out may be transmitted from the information terminal of the restaurant to the delivery management device 10.

Each of the above authentication information may be information that can be input by reading an image such as a one-dimensional code or two-dimensional code, information that key input such as a password can be entered, or information that can be transmitted and received by short-range wireless communication or the like.

### <Delivery Instruction Screen Displayed on Information Terminal 22 in Step S25 of FIG. 2>

FIG. 4 is a diagram illustrating an example of a delivery instruction screen displayed on the information terminal 22 in step S25 of FIG. 2. A touch panel 22a illustrated in FIG. 4 is a touch panel included in the user interface of the information terminal 22. In this example, a case will be described in which the battery delivery request information includes used battery return request information and food/drink delivery request information. In this case, in step S25 of FIG. 2, the information terminal 22 displays, for example, a delivery instruction screen 40 illustrated in FIG. 4 on the touch panel 22a.

The delivery instruction screen 40 includes delivery source location information 41, restaurant location information 42, delivery destination location information 43, return destination location information 44, navigation start buttons 41a, 42a, 43a, 44a, and code display buttons 41b, 42b, 43b, 44b.

The delivery source location information 41 is location information of the battery delivery source (for example, the storage device 5) selected by the delivery management device 10. When an instruction operation of the navigation start button 41a under the delivery source location information 41 is performed, the information terminal 22 starts navigation to the battery delivery source indicated by the delivery source location information 41 using a GPS or the like provided in the information terminal 22. Further, when an instruction operation of the code display button 41b is performed, the information terminal 22 displays the above-described battery acquisition authentication information (for example, a two-dimensional code), which is valid only at the battery delivery source, on the touch panel 22a.

The restaurant location information 42 is the location information of the restaurant instructed by the requester 1 using the food/drink delivery instruction button 33 described above. When an instruction operation of the navigation start button 42a under the food/drink delivery instruction button 33 is performed, the information terminal 22 starts navigation to the restaurant indicated by the restaurant location information 42 using the GPS or the like provided in the information terminal 22. Further, when an instruction operation of the code display button 42b is performed, the information terminal 22 displays the above-described food/beverage acquisition authentication information (for example, a two-dimensional code), which is valid only at the designated restaurant, on the touch panel 22a.

The delivery destination location information 43 is the location information of the battery delivery destination (for example, the location information of the information terminal 21), which is included in the above-described battery delivery request information. In this example, since the delivery request information also includes food/drink delivery request information, the delivery destination location information 43 is also the location information of the food/drink delivery destination. When an instruction operation of the navigation start button 43a under the delivery destination location information 43 is performed, the information terminal 22 starts navigation to the delivery destination indicated by the delivery destination location information 43 using the GPS or the like provided in the information terminal 22. Further, when the instruction operation of the code display button 43b is performed, the information terminal 22 displays the above-described delivery completion authentication information (for example, a two-dimensional code), which is valid only at the information terminal (for example, the information terminal 21) of the delivery destination, on the touch panel 22a.

The return destination location information 44 is the location information of the battery return destination (for example, the storage device 6) indicated by the return request information included in the battery delivery request information described above. When an instruction operation of the navigation start button 43a under the return destination location information 44 is performed, the information terminal 22 starts navigation to the return destination indicated by the return destination location information 44 using the GPS or the like provided in the information terminal 22. Further, when an instruction operation of the code display button 44b is performed, the information terminal 22 displays on the touch panel 22a the above-described battery return authentication information (for example, a two-dimensional code) that is valid only for the storage device at the battery return destination.

In the example of FIG. 4, the delivery source location information 41, restaurant location information 42, delivery destination location information 43, and return destination location information 44 are displayed in an address format such as “Tokyo . . . ”. However, the information is not limited to the address format, and may be displayed in the latitude and longitude format.

First, the delivery person 2 moves to the battery delivery source indicated by the delivery source location information 41 according to the navigation using the navigation start button 41a, and acquires the battery using the battery acquisition authentication information displayed using the code display button 41b.

Further, the delivery person 2 moves to the restaurant indicated by the restaurant location information 42 according to the navigation using the navigation start button 42a, and receives food/drink using the food/drink acquisition authentication information displayed using the code display button 42b.

In this example, it is up to the delivery person 2 to decide which one to go first, the battery delivery source or the restaurant, but for the delivery person 2 it may be designated which one to go to first, the battery delivery source or the restaurant. For example, based on each piece of the location information of the battery delivery source, restaurant, and deliverer, the delivery management device 10 determines which one to go to first, the battery delivery source or the restaurant, so that a delivery route becomes the shortest.

Next, the delivery person 2 moves to the delivery destination indicated by the delivery destination location information 43 according to the navigation using the navigation start button 43a, and delivers the battery and the food/drink. Further, the delivery person 2 notifies the delivery management device 10 of the completion of delivery using the delivery completion authentication information displayed using the code display button 43b. Further, the delivery person 2 receives the used battery from the requester 1 at the delivery destination to which the delivery person 2 has moved.

Next, the delivery person 2 moves to the return destination indicated by the return destination location information 44 according to the navigation using the navigation start button 44a, and returns the used battery using the battery return authentication information displayed using the code display button 44b.

In the example of FIG. 4, a case is described in which the delivery source location information 41, restaurant location information 42, delivery destination location information 43, and return destination location information 44 are displayed at the same time, but the information terminal 22 may display these pieces of information sequentially. For example, the information terminal 22 may first display the delivery source location information 41, the restaurant location information 42, the navigation start buttons 41a, 42a, and the code display buttons 41b, 42b.

Next, when each authentication using the code display buttons 41b, 42b is completed, the information terminal 22 displays the delivery destination location information 43, the navigation start button 43a, and the code display button 43b. Next, when the authentication using the code display button 43b is completed, the information terminal 22 may display the return destination location information 44, the navigation start button 44a, and the code display button 44b.

Regarding a delivery completion authentication method, a method is described in which the delivery completion authentication information displayed using the code display button 43b is read into the information terminal of the delivery destination, but the method is not limited to this method. For example, when the delivery request information is transmitted to the delivery management device 10, a confirmation code may be transmitted from the delivery management device 10 only to the information terminal 21 of the requester 1, and delivery completion authentication may be performed by inputting the confirmation code into the information terminal 22 of the delivery person 2. In this case, for example, the delivery instruction screen 40 includes a confirmation code input area or a button for displaying the confirmation code input area in place of the code display button 43b. When the confirmation code is input in this input area, notification information indicating that the delivery has been completed is transmitted from the information terminal 22 to the delivery management device 10.

<Information on Storage Device Candidates that Delivery Management Device 10 can Acquire>

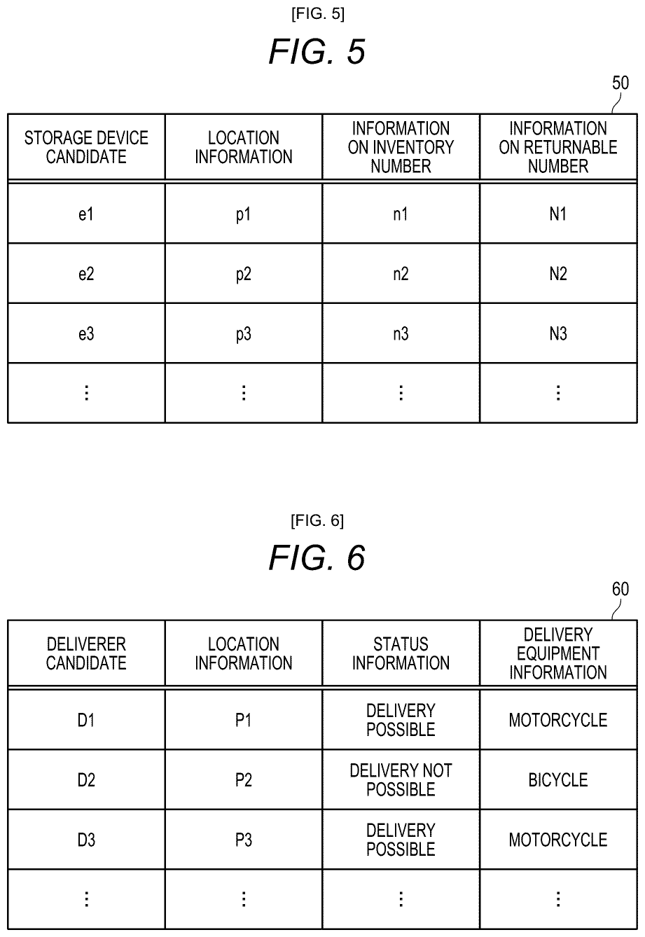

FIG. 5 is a diagram illustrating an example of information on storage device candidates that the delivery management device 10 can acquire. The delivery management device 10 can acquire storage device candidate information 50 illustrated in FIG. 5, for example. In the storage device candidate information 50, location information (p1, p2, p3, . . . ), information on inventory number (n1, n2, n3, . . . ), and information on returnable number (N1, N2, N3, . . . ) are associated with each storage device candidate (e1, e2, e3, . . . ) registered in advance. The storage devices 5 and 6 illustrated in FIG. 1 are included in the storage device candidates (e1, e2, e3, . . . ).

The location information of the storage device candidate is added to the storage device candidate information 50 when the delivery management device 10 starts operating or when the storage device candidate starts operating.

The information on the inventory number of the storage device candidate is information indicating the number of batteries that can be delivered from the storage device candidate. The number of batteries that can be delivered from the storage device candidate is, for example, the number of batteries that are stored by the storage device candidate and of which delivery is not reserved. Also, when the storage device candidate charges the battery, the number of batteries that can be delivered from the storage device candidate may be the number of batteries that are stored by the storage device candidate, are not reserved for delivery, and are fully charged (or will be fully charged in a short period of time).

The information on the returnable number related to the storage device candidate is information indicating the number of used batteries that can be returned to the storage device candidate. The number of used batteries that can be returned to a storage device candidate is the number (for example, number of free slots) obtained, for example, by subtracting the number of batteries stored by the storage device candidate from the number (for example, total number of slots) of batteries that can be stored by the storage device candidate. Also, the number of used batteries that can be returned to the storage device candidate may be the number of used batteries that can be returned to the storage device candidates in the near future, which is based on the delivery schedule of batteries from the storage device candidate, the return schedule of batteries to the storage device candidate, and the like.

For example, when the delivery management device 10 manages battery delivery and return for all storage device candidates, the delivery management device 10 can acquire information on inventory number and information on returnable number based on a management history of delivery and return of batteries in the storage device candidates. Alternatively, the delivery management device 10 may acquire information on inventory number and information on returnable number by communicating with each of the storage device candidates.

<Information on Deliverer Candidates that Delivery Management Device 10 can Acquire>

FIG. 6 is a diagram illustrating an example of information on deliverer candidates that can be acquired by the delivery management device 10. The delivery management device 10 can acquire deliverer candidate information 60 illustrated in FIG. 6, for example. In the deliverer candidate information 60, for each deliverer candidate (D1, D2, D3, . . . ) registered in advance, location information (P1, P2, P3, . . . ), status information (“delivery possible”, “delivery not possible”, “delivery possible”, . . . ), and delivery apparatus information (“motorcycle”, “bicycle”, “motorcycle”, . . . ) are associated. The delivery person 2 illustrated in FIG. 1 is included in the deliverer candidates (D1, D2, D3, . . . ).

The location information of the deliverer candidate is, for example, location information acquired by GNSS or the like of an information terminal (for example, the information terminal 22 of the delivery person 2) owned by the deliverer candidate. The delivery management device 10 acquires location information of the deliverer candidate by, for example, periodically communicating with the information terminal owned by the deliverer candidate.

The status information of the deliverer candidate is information indicating whether the deliverer candidate is currently in a state where it is possible to deliver a battery. For example, the status information of the deliverer candidate will be “delivery possible” when the deliverer candidate is in a waiting state for delivery, and will be “delivery not possible” when the deliverer candidate is not in a waiting state. The status information of the deliverer candidate is set, for example, by operating the deliverer candidate's information terminal or by delivery request information for the deliverer candidate. The delivery management device 10 acquires status information of the deliverer candidate, for example, by periodically communicating with the information terminal owned by the deliverer candidate, or based on a history of transmitting delivery request information to the deliverer candidate.

The delivery apparatus information of the deliverer candidate is information regarding the apparatus used by the deliverer candidate for delivery. In the example in FIG. 6, the delivery apparatus information is “motorcycle” or “bicycle”, but the delivery apparatus information may be information such as the number of batteries that can be loaded (or the weight that can be loaded) in the apparatus used by the deliverer candidate for delivery. Further, the delivery apparatus information may include information regarding equipment used for delivering food/drink, such as whether the equipment has a heat retention function or a vibration isolation function.

### <Processing by Delivery Management Device 10>

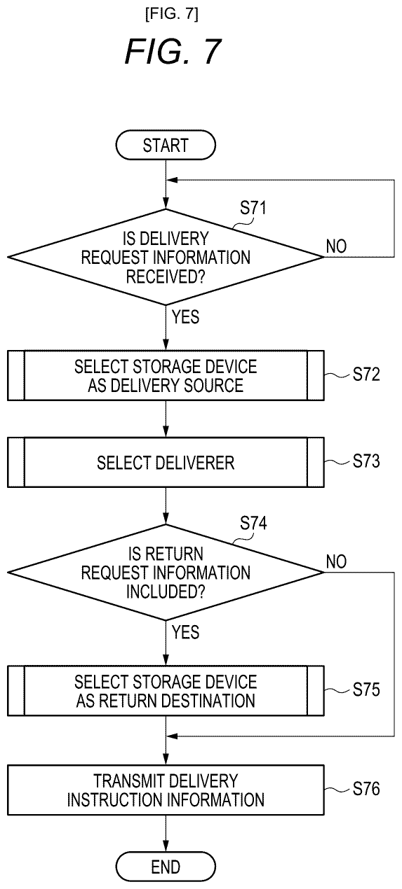

FIG. 7 is a flowchart illustrating an example of processing by the delivery management device 10. First, the delivery management device 10 determines whether battery delivery request information has been received from an information terminal such as the information terminal 21 (step S71), and waits until the delivery request information is received (step S71: No loop).

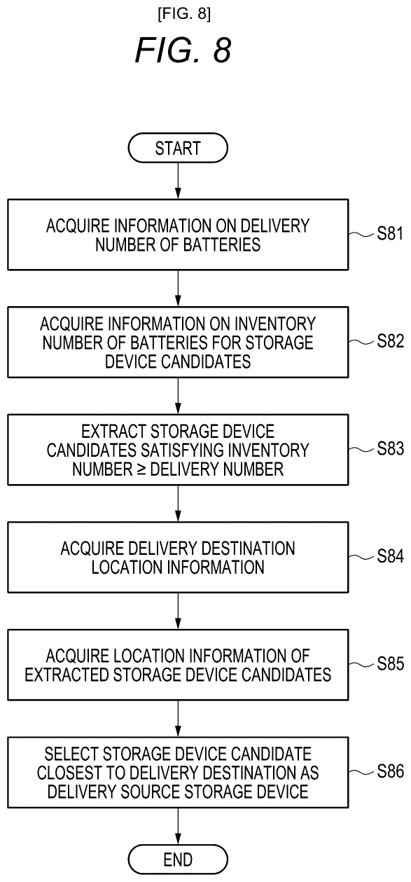

In step S71, when receiving the delivery request information (step S71: Yes), the delivery management device 10 selects a storage device as a battery delivery source from among the storage device candidates registered in advance (step S72). A specific example of the process in step S72 will be described below (see, for example, FIG. 8).

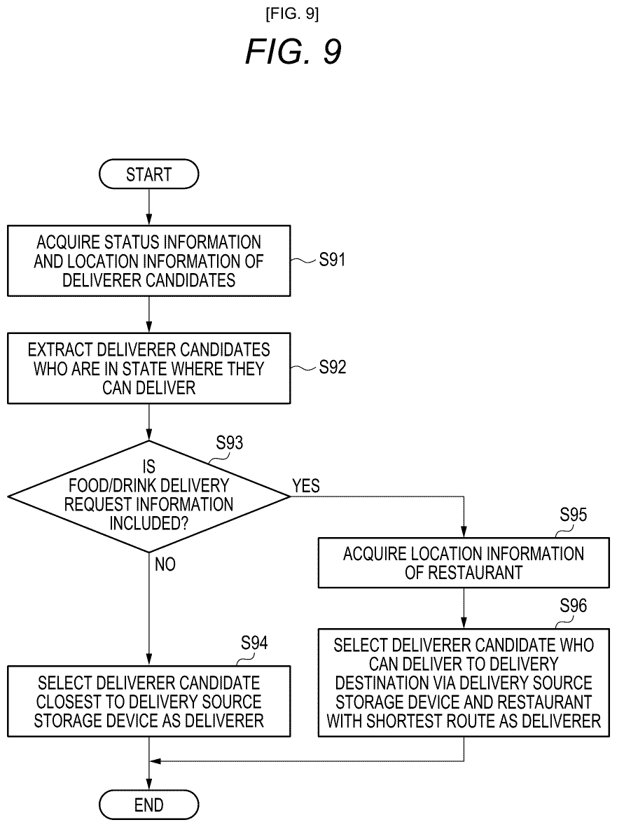

Next, the delivery management device 10 selects a battery deliverer from the deliverer candidates registered in advance (step S73). A specific example of the process in step S73 will be described below (for example, see FIG. 9).

Next, the delivery management device 10 determines whether the received delivery request information includes used battery return request information (step S74). When the delivery request information does not include return request information (step S74: No), the delivery management device 10 moves to step S76.

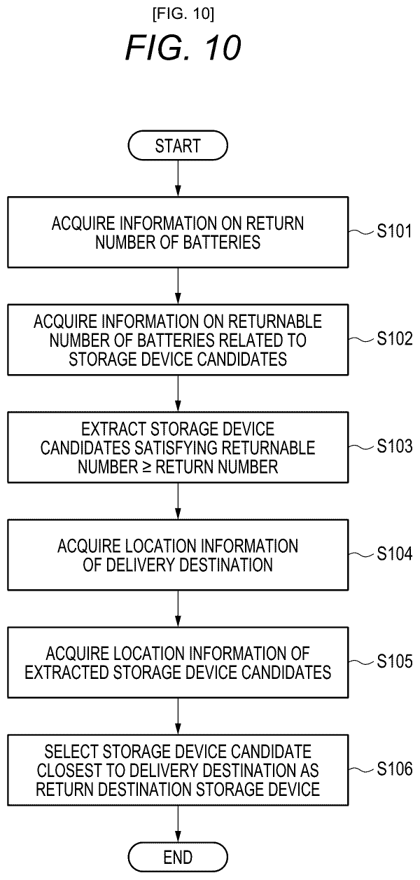

In step S74, when the delivery request information includes return request information (step S74: Yes), the delivery management device 10 selects the storage device as a battery return destination from among the storage device candidates registered in advance (step S75). A specific example of the process in step S75 will be described below (see, for example, FIG. 10).

Next, the delivery management device 10 transmits the delivery instruction information to the deliverer selected in step S73 (step S76), and ends the series of processing.

### <Specific Example of Step S72 in FIG. 7>

FIG. 8 is a flowchart illustrating a specific example of step S72 in FIG. 7. In step S72 of FIG. 7, the delivery management device 10 executes the process illustrated in FIG. 8, for example. First, the delivery management device 10 acquires information on delivery number of batteries from the received delivery request information (step S81). The delivery management device 10 also acquires information on inventory number of batteries for the storage device candidates registered in advance from the storage device candidate information 50 illustrated in FIG. 5 (step S82).

Next, the delivery management device 10 extracts storage device candidates for which the inventory number of batteries indicated by the information on the inventory number is equal to or greater than the delivery number of batteries indicated by the information on the delivery number from among the storage device candidates registered in advance (step S83).

Next, the delivery management device 10 acquires the delivery destination location information from the received delivery request information (step S84). The delivery management device 10 also acquires the location information of the storage device candidates extracted in step S83 from the storage device candidate information 50 illustrated in FIG. 5 (step S85).

Next, the delivery management device 10 selects the storage device candidate closest to the delivery destination as the delivery source storage device from among the storage device candidates extracted in step S83 based on the location information acquired in steps S84, S85 (step S86), and then the delivery management device 10 ends the process of step S72 in FIG. 7.

In addition, when there is no storage device among the storage device candidates of which the inventory number of batteries is equal to or greater than the delivery number of batteries, the delivery management device 10 may select a plurality of storage devices from among the storage device candidates as delivery source storage devices. In this case, the deliverer will have to visit the plurality of storage devices to acquire batteries.

Although a process is described in which the storage device candidate closest to the delivery destination is selected as the delivery source storage device from among the storage device candidates for which the inventory number of batteries is equal to or greater than the delivery number of batteries, the process is not limited to this. For example, the delivery management device 10 may select the storage device candidate of which the distance from the delivery destination is equal to or less than a processing value and which has the highest inventory number of batteries from among the storage device candidates of which the inventory number of batteries is equal to or greater than the delivery number of batteries, as the delivery source storage device.

Alternatively, the delivery management device 10 may select, as the delivery source storage device, the storage device candidate with the highest evaluation value based on the following equation (1) from among the storage device candidates for which the inventory number of batteries is equal to or greater than the delivery number of batteries. A and B in the following equation (1) are predetermined positive coefficients.

$$Evaluation value = A \times ( inventory number of batteries ) - B \times ( distance from delivery denstination ) \qquad ( 1 )$$

That is, the delivery management device 10 preferentially selects the storage device candidate closest to the delivery destination as the delivery source storage device. As a result, it is possible to select a delivery source storage device that allows the deliverer to efficiently deliver batteries. Further, the delivery management device 10 preferentially selects a storage device candidate with a larger inventory number of batteries as the delivery source storage device. This makes it possible to select a delivery source storage device that can equalize the inventory number of batteries for each storage device.

### <Specific Example of Step S73 in FIG. 7>

FIG. 9 is a flowchart illustrating a specific example of step S73 in FIG. 7. In step S73 of FIG. 7, the delivery management device 10 executes the process illustrated in FIG. 9, for example. First, the delivery management device 10 acquires status information and location information of deliverer candidates registered in advance from the deliverer candidate information 60 illustrated in FIG. 6 (step S91).

Next, the delivery management device 10 extracts deliverer candidates who are in a state where they can deliver the battery from among the deliverer candidates registered in advance, based on the deliverer candidate status information acquired in step S91 (step S92).

Next, the delivery management device 10 determines whether the received delivery request information includes food/drink delivery request information (step S93). When the delivery request information does not include food/drink delivery request information (step S93: No), the delivery management device 10 selects the deliverer candidate closest to the delivery source storage device as a deliverer from among the deliverer candidates extracted in step S92 based on the location information of the delivery source storage device selected in step S72 of FIG. 7 and the location information of the deliverer candidate acquired in step S91 (step S94), and then the delivery management device 10 ends the process of step S73 in FIG. 7.

In step S93, when the delivery request information includes food/drink delivery request information (step S93: Yes), the delivery management device 10 acquires the location information of the restaurant designated by the food/drink delivery request information (step S95). The restaurant location information is included in the food/drink delivery request information, for example. Alternatively, the location information of the restaurant is acquired based on correspondence information that associates the identification information of the restaurant with the location information of the restaurant. This correspondence information may be stored in the memory of the delivery management device 10, or may be stored in another device that the delivery management device 10 can access.

Next, the delivery management device 10 selects as a deliverer a deliverer candidate who can deliver to the delivery destination via the delivery source storage device and the restaurant with the shortest route based on the location information of the restaurant acquired in step S95, the location information of the delivery source storage device selected in step S72 of FIG. 7, and the location information of the deliverer candidate acquired in step S91 (step S96), and then the delivery management device 10 ends the process of step S73 in FIG. 7.

In addition, the delivery management device 10 may acquire apparatus information of the deliverer candidate from the deliverer candidate information 60 illustrated in FIG. 6 in step S91, and the delivery management device 10 may limit the deliverer candidates extracted in step S92 to those who can deliver the number of batteries indicated by the information on the delivery number included in the delivery request information. In addition, when the delivery request information includes food/drink delivery request information, the delivery management device 10 may limit the deliverer candidates extracted in step S92 to deliverer candidates who have delivery apparatus that can deliver the target food/drink.

### <Specific Example of Step S75 in FIG. 7>

FIG. 10 is a flowchart illustrating a specific example of step S75 in FIG. 7. In step S75 of FIG. 7, the delivery management device 10 executes the process illustrated in FIG. 10, for example. First, the delivery management device 10 acquires information on a return number of batteries from the return request information of the received delivery request information (step S101). The delivery management device 10 also acquires information on a returnable number of batteries related to the storage device candidates registered in advance from the storage device candidate information 50 illustrated in FIG. 5 (step S102).

Next, the delivery management device 10 extracts storage device candidates from among the storage device candidates registered in advance, for which the inventory number of batteries indicated by the information on the returnable number is equal to or greater than the return number of batteries indicated by the information on the return number (step S103).

Next, the delivery management device 10 acquires the location information of the delivery destination from the return request information of the received delivery request information (step S104). The delivery management device 10 also acquires the location information of the storage device candidates extracted in step S103 from the storage device candidate information 50 illustrated in FIG. 5 (step S105).

Next, the delivery management device 10 selects the storage device candidate closest to the delivery destination as a return destination storage device from among the storage device candidates extracted in step S103 based on the location information acquired in steps S104, S105 (step S106), and then the delivery management device 10 ends the process of step S75 in FIG. 7.

In addition, when there is no storage device among the storage device candidates for which the returnable number of batteries is equal to or greater than the return number of batteries, the delivery management device 10 may select a plurality of storage devices from among the storage device candidates as return destination storage devices. In this case, the deliverer will have to return the batteries to the plurality of storage devices.

Although a process is described in which the storage device candidate closest to the delivery destination is selected as the return destination storage device from among the storage device candidates for which the returnable number of batteries is equal to or greater than the return number of batteries, the present invention is not limited to such a process. For example, the delivery management device 10 may select as the return destination storage device the storage device candidate of which the distance from the delivery destination is equal to less than a processing value and which has the highest returnable number of batteries from among the storage device candidates of which returnable number of batteries is equal to or greater than the return number of batteries.

Alternatively, the delivery management device 10 may select the storage device candidate with the highest evaluation value based on the following equation (2) from among the storage device candidates for which the returnable number of batteries is equal to or greater than the return number of batteries as the return destination storage device. C and D in the following equation (2) are predetermined positive coefficients.

$$Evaluation value = C \times ( returnable number of batteries ) - D \times ( distance from delivery destination ) \qquad ( 2 )$$

That is, the delivery management device 10 preferentially selects the storage device candidate closest to the delivery destination as the return destination storage device. As a result, it is possible to select the return destination storage device that allows the deliverer to return the battery efficiently. Further, the delivery management device 10 preferentially selects storage device candidates with a larger returnable number of batteries as the return destination storage device. as a result, it is possible to select a return destination storage device that can equalize the returnable number of batteries (empty slots) of each storage device.

Further, although the process of selecting a return destination storage device based on the distance from the delivery destination is described, the delivery management device 10 may select a return destination storage device based on the distance from the deliverer. The distance from the deliverer is the distance from the deliverer at the time when the delivery management device 10 receives the delivery request information. For example, in step S106, the delivery management device 10 may select the storage device candidate closest to the deliverer selected in step S73 as the return destination storage device.

Alternatively, the delivery management device 10 may select the storage device candidate with the highest evaluation value based on the following equation (3) or the following equation (4) from among the storage device candidates for which the returnable number of batteries is equal to or greater than the return number of batteries as the return destination storage device. E, F, and G in the following equation (3) and equation (4) are predetermined positive coefficients.

$$Evaluation value = - F \times ( distance from delivery destination ) - G \times ( distance from deliverer ) \qquad ( 3 )$$

$$Evaluation value = E \times ( returnable number of batteries ) - F \times ( distance from delivery destination ) - G \times ( distance from deliverer ) \qquad ( 4 )$$

That is, the delivery management device 10 preferentially selects the storage device candidate closest to the deliverer as the return destination storage device. As a result, it is possible to select a return destination storage device that allows the deliverer to efficiently return to his or her original location after returning the used battery.

As described above, based on the battery delivery request information including the location information of the delivery destination, the delivery management device 10 transmits delivery instruction information including location information of a storage device storing a battery that can be delivered to the delivery destination and location information of the delivery destination to the deliverer. Further, as described in FIG. 9, the delivery management device 10 selects a battery deliverer from among deliverer candidates registered in advance based on the location information of the deliverer candidate and the location information of the delivery source storage device. This makes it possible to select a deliverer who is close to the battery delivery source and who can efficiently deliver the battery to the delivery destination, and to transmit delivery instruction information to that deliverer.

Alternatively, the delivery management device 10 may select the battery deliverer from among the deliverer candidates registered in advance, based on the location information of the deliverer candidates and the location information of the delivery destination. As a result, when the delivery management device 10 receives the delivery request information, it is possible to select a deliverer who is close to the battery delivery destination and who can efficiently return to his or her original location after delivering the battery, and to transmit delivery instruction information to that deliverer.

Alternatively, the delivery management device 10 may select the battery deliverer from among the deliverer candidates registered in advance based on the location information of the deliverer candidates, the location information of the delivery source, and the location information of the delivery destination. For example, the delivery management device 10 may select, as the deliverer, a deliverer candidate whose route is the shortest from the location at the time of receiving the delivery request information to the original location via the delivery source and delivery destination. The deliverer candidate with the shortest route may be the deliverer candidate with the shortest route length, or may be the deliverer candidate with the shortest route travel time. As a result, it is possible to select the deliverer who can efficiently deliver the battery to the delivery destination and efficiently return to his or her original location after delivering the battery, and transmit delivery instruction information to that deliverer.

In this way, according to the delivery management device 10, a battery can be delivered efficiently. By increasing the efficiency of battery delivery, battery delivery costs can be reduced. Additionally, the battery delivery requester can receive the battery in a short time after making the request. Further, a delivery requester who requests food/drink that requires cooking along with a battery can receive the food/drink that has been cooked for a short time.

### <Another Example of Delivery Instruction Screen 40>

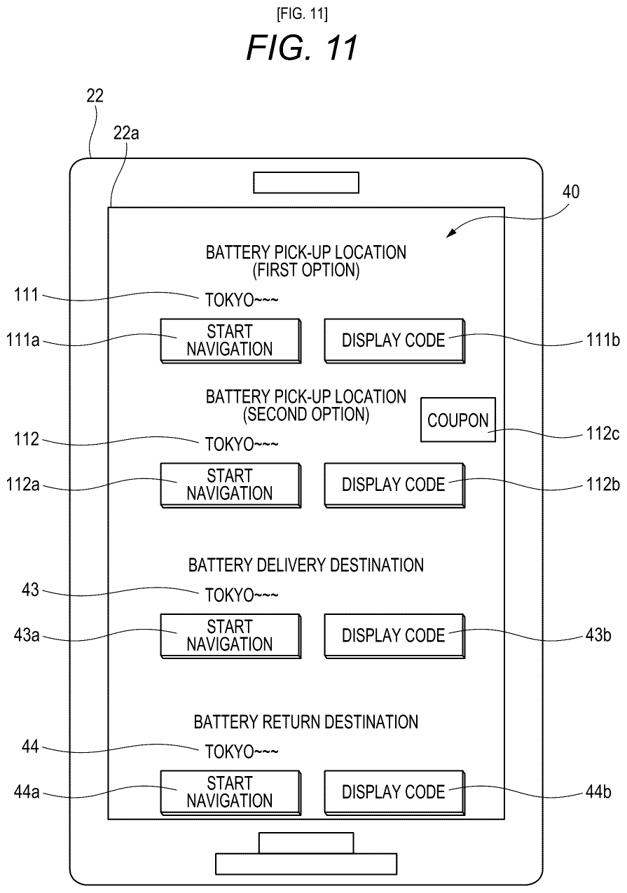

FIG. 11 is a diagram illustrating another example of the delivery instruction screen 40. In this example, a case will be described in which the battery delivery request information includes used battery return request information. It is also assumed that the delivery management device 10 selects two storage devices as selectable delivery source storage devices for the delivery person 2 in step S23. In this case, the delivery management device 10 includes the location information of the two selected storage devices in the delivery instruction information transmitted in step S24. In this case, in step S25 of FIG. 2, the information terminal 22 displays, for example, the delivery instruction screen 40 illustrated in FIG. 11 on the touch panel 22a.

The delivery instruction screen 40 illustrated in FIG. 11 includes delivery source location information 111, 112, the delivery destination location information 43, the return destination location information 44, navigation start buttons 43a, 44a, 111a, 112a, code display buttons 43b, 44b, 111b, 112b, and coupon information 112c.

The delivery source location information 111 is location information of a first option of the battery delivery source selected by the delivery management device 10. When an instruction operation of the navigation start button 111a under the delivery source location information 111 is performed, the information terminal 22 starts navigation to the battery delivery source indicated by the delivery source location information 111. Further, when an instruction operation of the code display button 111b is performed, the information terminal 22 displays battery acquisition authentication information (for example, a two-dimensional code) that is valid only for the first option of the battery delivery source on the touch panel 22a.

The delivery source location information 112 is location information of a second option of the battery delivery source selected by the delivery management device 10. When an instruction operation of the navigation start button 112a under the delivery source location information 112 is performed, the information terminal 22 starts navigation to the battery delivery source indicated by the delivery source location information 112. Further, when the instruction operation of the code display button 112b is performed, the information terminal 22 displays battery acquisition authentication information (for example, a two-dimensional code) that is valid only for the second option of the battery delivery source on the touch panel 22a.

The coupon information 112c is information indicating that a coupon will be given to the delivery person 2 when a battery is acquired from the second option of the battery delivery source and delivered. The coupon is incentive information that serves as an incentive for the delivery person 2, such as a coupon that can be used to purchase a product.

For example, the second option of the battery delivery source is farther from the delivery destination or delivery person 2 than the first option of the battery delivery source, but is a delivery source that has advantages for an operating side of the delivery system 100, such as having a large inventory number of batteries. In such a case, the delivery management device 10 adds coupon information to the second option of the battery delivery source. Based on this coupon information, the information terminal 22 displays the coupon information 112c along with the second option of the battery delivery source.

In this case, when the battery is acquired using the battery acquisition authentication information displayed by the code display button 112b corresponding to the second option of the battery delivery source, and notification information to that effect is transmitted, the delivery management device 10 gives a coupon to the delivery person 2. A coupon can be given to the delivery person 2 by transmitting a coupon code to the information terminal 22, for example.

In this way, the delivery management device 10 includes, in the delivery instruction information, the location information of a plurality of storage devices that store batteries that can be delivered to the delivery destination, and the delivery management device 10 provides incentive information to the delivery person 2 according to the storage device from which the delivery person 2 has acquired the battery by among the plurality of storage devices. This gives the delivery person 2 an incentive to deliver batteries from a delivery source that is far away from the delivery destination or delivery person 2 but has a large inventory number of batteries or the like, and is advantageous for an operating side of the delivery system 100, in such a manner that it is possible to improve the efficiency of storage device inventory management or the like.

Further, the delivery person 2 may be allowed to select a storage device as a used battery return destination, and incentive information may be provided to the delivery person 2 according to the selection result. That is, the delivery management device 10 may include location information of a plurality of storage devices to which used batteries can be returned in the delivery instruction information, and the delivery management device 10 may provide incentive information to the delivery person 2 according to the storage device to which the delivery person 2 has returned the used battery among the plurality of storage devices. This gives the delivery person 2 an incentive to return the used battery to a return destination that is far away from the delivery destination or delivery person 2 but has advantages for an operating side of the delivery system 100, such as a small inventory number of batteries, so it is possible to improve the efficiency of storage device inventory management or the like.

In addition, the provision of incentive information to the delivery person 2 is information processing that benefits the delivery person 2, and is not limited to the provision of coupons, but may also include an increase in compensation for the delivery person 2 regarding delivery based on the delivery instruction information.

### <Specific Example of Usage of Delivery System 100>

For example, the requester 1 is an operator of an event venue such as a large-scale outdoor music festival. In this case, the requester 1 uses the portable discharge machine 7 as a power source to drive electronic equipment used for holding the event, such as audio equipment and lighting equipment, for example, and the requester 1 uses a battery delivered by the delivery system 100 as a battery to be attached to the portable discharge machine 7. In this case, the requester 1 can also request delivery of food/drink along with the battery.

Alternatively, the requester 1 may be a participant at an event venue such as a large-scale outdoor music festival. In this case, the requester 1 uses the portable discharge machine 7, for example, to charge a mobile information terminal such as a smartphone. Further, when the requester 1 stays at an outdoor event venue, the portable discharge machine 7 may be used as a power source for driving electronic equipment such as lighting equipment and cooking equipment. The requester 1 uses a battery delivered by the delivery system 100 as a battery to be attached to the portable discharge machine 7. In this case, the requester 1 can also request delivery of food/drink along with the battery.

However, the delivery system 100 can be used not only at event venues but also at various places where batteries or batteries and food/drinks are used, such as landscaping work sites and construction work sites. Further, a thing where the battery can be attached is not limited to the portable discharge machine 7, but may be any type of electronic equipment to which the battery can be attached, such as a battery-powered mower or a battery-powered industrial machine.

Although the embodiment of the present invention is described above, the present invention is not limited to the above-described embodiment, and can be modified, improved, or the like as appropriate. For example, although the delivery person 2 is described as a deliverer who delivers batteries, the deliverer may be a store or the like that has the delivery person. In this case, the delivery management device 10 transmits the delivery instruction information to the information terminal of the store that is the deliverer. In this case, the store clerk prints out the delivery instruction information received by the information terminal and makes the delivery.

In FIG. 7, the process of selecting the return destination storage device after selecting the deliverer is described, but the delivery management device 10 may select the deliverer after selecting the return destination storage device. In this case, the delivery management device 10 may, for example, preferentially select a deliverer candidate closer to the return destination storage device as a deliverer. This makes it possible to select a deliverer who can efficiently return to the original location after returning the used battery.

In the example of FIG. 1, the information terminals 21, 22 are smartphones, but the information terminals 21, 22 are not limited to smart odins, but may be information terminals such as tablet terminals or notebook-type personal computers (PCs).

Communication between the delivery management device 10 and the information terminals 21, 22 may be wired communication instead of wireless communication. Further, the communication between the delivery management device 10 and the information terminals 21, 22 may be communication via a network instead of direct communication.

Further, this specification describes at least the following matters. Although components corresponding to those in the above-described embodiment are shown in parentheses, the present invention is not limited thereto.

(1) A delivery management device (delivery management device 10) for selecting a deliverer based on delivery request information of a battery including location information of a delivery destination, and for transmitting delivery instruction information to the deliverer, where
the delivery instruction information includes location information (delivery source location information 41, 111, 112) of a storage device (storage device 5) storing a battery that can be delivered to the delivery destination and the location information (delivery destination location information 43) of the delivery destination, and
the deliverer is selected from deliverer candidates registered in advance based on location information (deliverer candidate information 60) of the deliverer candidates and at least one of the location information of the storage device and the location information of the delivery destination.

According to (1), for example, as illustrated in FIG. 9, it is possible to select a deliverer who is close to the battery storage device and delivery destination and who can efficiently deliver the battery, and to transmit the delivery instruction information to that deliverer.

(2) The delivery management device according to (1), where
the delivery request information includes information on a delivery number of batteries, and
the storage device is selected from storage device candidates registered in advance based on information on an inventory number of batteries (storage device candidate information 50) in the storage device candidates and the information on the delivery number of batteries.

According to (2), for example, as illustrated in FIG. 8, a storage device having the number of batteries requested by the delivery request information can be selected as a delivery source storage device.

(3) The delivery management device according to (1) or (2), where
the storage device is selected from storage device candidates registered in advance based on the location information (storage device candidate information 50) of the storage device candidates.

According to (3), for example, as illustrated in FIG. 8, it is possible to select a delivery source storage device that is close to the battery delivery destination and can efficiently deliver the battery to the delivery destination.

(4) The delivery management device according to any one of (1) to (3), where
the delivery request information further includes food/drink delivery request information to a restaurant,
the delivery instruction information includes location information (restaurant location information 42) of the restaurant, and
the deliverer is selected based on the location information of the restaurant.

According to (4), for example, as illustrated in FIG. 9, it is possible to select a deliverer who can efficiently deliver food/drink together with a battery, and transmit the delivery instruction information to that deliverer.

(5) The delivery management device according to any one of (1) to (4), where
the delivery instruction information includes authentication information (code display button 41b) that is authenticated only by the storage device.

According to (5), authentication is possible between the designated delivery source storage device and the deliverer, and thus it is possible to prevent a battery from being acquired from a storage device different from the designated storage device.

(6) The delivery management device according to any one of (1) to (5), where
the delivery instruction information includes location information (delivery source location information 111, 112) of a plurality of storage devices that store batteries that can be delivered to the delivery destination, and
incentive information is provided to the deliverer according to a storage device from which the battery is acquired by the deliverer among the plurality of storage devices.

According to (6), for example, as illustrated in FIG. 11, by giving the deliverer an incentive to deliver batteries from a storage device that is advantageous for an operating side of the delivery system, such as a storage device that is far from the delivery destination or deliverer but has a large inventory number of batteries, it can improve the efficiency of storage device inventory management or the like.

(7) The delivery management device according to any one of (1) to (6), where
the delivery request information further includes return request information of a used battery,
the delivery instruction information includes location information of a storage device as a return destination to which the used battery can be returned, and
the storage device as the return destination is selected from storage device candidates registered in advance based on location information (storage device candidate information 50) of the storage device candidates.

According to (7), for example, as illustrated in FIG. 10, for example, it is possible to select a return destination storage device that is close to the battery delivery destination and allows the deliverer to efficiently return the used battery after delivering the battery. Alternatively, it is possible to select a return destination storage device that is close to the deliverer and is easy for the deliverer to return to the original location after returning the used battery.

(8) The delivery management device according to (7), where
the return request information includes information on a return number of used batteries, and
the storage device as the return destination is selected from the storage device candidates registered in advance based on information on a returnable number of batteries in the storage device candidates and the information on the return number of used batteries.

According to (8), for example, as illustrated in FIG. 10, a storage device to which the number of used batteries requested by the return request information can be returned can be selected as a return destination storage device.

(9) The delivery management device according to (7) or (8), where
the storage device as the return destination is selected from the storage device candidates registered in advance based on the information on the inventory number of batteries in the storage device candidates.

According to (9), for example, a storage device candidate with a small inventory number can be selected as the return destination storage device, thereby making it possible to equalize the inventory number among the storage devices.

(10) The delivery management device according to any one of (7) to (9), where
the deliverer is selected based on location information of the storage device as the return destination.

According to (10), for example, it is possible to select a deliverer who is close to the return destination storage device and who is easy to return to the original location after returning the battery.

(11) The delivery management device according to any one of (7) to (10), where
the delivery instruction information includes authentication information (code display button 44b) that is authenticated only by the storage device as the return destination.

According to (11), authentication is possible between the designated return destination storage device and the deliverer, and thus it is possible to prevent the battery from being returned to a storage device different from the designated return destination storage device.

(12) The delivery management device according to any one of (7) to (11), where
the delivery instruction information includes location information of a plurality of storage devices as return destinations to which the used battery can be returned, and
incentive information is provided to the deliverer according to the storage device to which the used battery is returned among the plurality of storage devices as the return destinations.

According to (12), for example, as illustrated in FIG. 11, by giving the deliverer an incentive to return batteries to a storage device that is advantageous for an operating side of the delivery system, such as a storage device that is far from the delivery destination or deliverer but has a small inventory number of batteries, it can improve the efficiency of storage device inventory management or the like.

(13) The delivery management device according to any one of (1) to (12), where
the deliverer is selected based on information (deliverer candidate information 60) on delivery apparatus used by each of the deliverer candidates for delivery.

According to (13), it is possible to select a deliverer who has delivery apparatus suitable for delivering a battery.

### REFERENCE SIGNS LIST

5: storage device
10: delivery management device
42: restaurant location information (location information)
43: delivery destination location information (location information)
41b, 44b: code display button (authentication information)
50: storage device candidate information (location information, information on inventory number)
60: deliverer candidate information (location information, delivery apparatus information)

1. A delivery management device for selecting a deliverer based on delivery request information of a battery including location information of a delivery destination, and for transmitting delivery instruction information to the deliverer, wherein
the delivery instruction information includes location information of a storage device storing a battery that can be delivered to the delivery destination and the location information of the delivery destination, and
the deliverer is selected from deliverer candidates registered in advance based on location information of the deliverer candidates and at least one of the location information of the storage device and the location information of the delivery destination.

2. The delivery management device according to claim 1, wherein
the delivery request information includes information on a delivery number of batteries, and
the storage device is selected from storage device candidates registered in advance based on information on an inventory number of batteries in the storage device candidates and the information on the delivery number of batteries.

3. The delivery management device according to claim 1, wherein
the storage device is selected from storage device candidates registered in advance based on the location information of the storage device candidates.

4. The delivery management device according to claim 1, wherein
the delivery request information further includes food/drink delivery request information to a restaurant,
the delivery instruction information includes location information of the restaurant, and
the deliverer is selected based on the location information of the restaurant.

5. The delivery management device according to claim 1, wherein
the delivery instruction information includes authentication information that is authenticated only by the storage device.

6. The delivery management device according to claim 1, wherein
the delivery instruction information includes location information of a plurality of storage devices that store batteries that can be delivered to the delivery destination, and
incentive information is provided to the deliverer according to a storage device from which the battery is acquired by the deliverer among the plurality of storage devices.

7. The delivery management device according to claim 1, wherein
the delivery request information further includes return request information of a used battery,
the delivery instruction information includes location information of a storage device as a return destination to which the used battery can be returned, and
the storage device as the return destination is selected from storage device candidates registered in advance based on location information of the storage device candidates.

8. The delivery management device according to claim 7, wherein
the return request information includes information on a return number of used batteries, and
the storage device as the return destination is selected from the storage device candidates registered in advance based on information on a returnable number of batteries in the storage device candidates and the information on the return number of used batteries.

9. The delivery management device according to claim 7, wherein
the storage device as the return destination is selected from the storage device candidates registered in advance based on the information on the inventory number of batteries in the storage device candidates.

10. The delivery management device according to claim 7, wherein
the deliverer is selected based on location information of the storage device as the return destination.

11. The delivery management device according to claim 7, wherein
the delivery instruction information includes authentication information that is authenticated only by the storage device as the return destination.

12. The delivery management device according to claim 7, wherein
the delivery instruction information includes location information of a plurality of storage devices as return destinations to which the used battery can be returned, and
incentive information is provided to the deliverer according to a storage device to which the used battery is returned among the plurality of storage devices as the return destinations.

13. The delivery management device according to claim 1, wherein
the deliverer is selected based on information on delivery apparatus used by each of the deliverer candidates for delivery.
